(19) United States
(12) Patent Application Publication
(10) Pub. No.: US 2007/0092094 A1
(43) Pub. Date: Apr. 26, 2007

(54) System and method for an adaptor for interconnecting a hearing assistance device to a sound conduit

(76) Inventor: Mark D. Gilbertson, St. Louis Park, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/258,842

(22) Filed: Oct. 26, 2005

(51) Int. Cl. H04R 25/00

(52) U.S. Cl. 381/328; 381/324

(57) ABSTRACT

One embodiment of the present subject matter includes a hearing assistance device housing shaped to fit at least partially behind the ear, the hearing assistance device housing containing a microphone, sound processing electronics, and a speaker to deliver sound to a spout at an aperture in the hearing assistance device housing; an adaptor having an adaptor passage acoustically sealed to the aperture in the hearing assistance device housing; and a sound conduit defining a lumen which is acoustically sealed, at a proximal portion, to the adaptor passage of the adaptor.

### TECHNICAL FIELD

This disclosure relates generally to hearing assistance devices, and more particularly to a system and method for an adaptor for interconnecting hearing assistance devices to sound conduit.

### BACKGROUND

Hearing assistance devices are available to help users hear. Some hearing assistance device designs include a threaded spout. This spout extends from the hearing assistance device housing and allows for the connection of some hearing assistance device parts. But some parts are unable to efficiently connect to this spout. An incompatible fit between a part and the spout can introduce an air gap. An air gap can cause feedback problems and can decrease performance.

An inability to connect parts to the sound conduit causes additional problems. One problem is that users are not able to retrofit parts to the spout if the parts cannot form an acoustic seal with the spout. This can force hearing assistance device users to completely replace their hearing assistance device system. Additionally, users may seek to mix parts made by different manufactures. This is not possible if parts are incompatible and cannot from an acoustic seal. As such, what is needed is a way to connect incompatible parts to a threaded spout so that an acoustic seal exists between the incompatible part and the hearing assistance device.

### SUMMARY

The above-mentioned problems and others not expressly discussed herein are addressed by the present subject matter and will be understood by reading and studying this specification.

One embodiment of the present subject matter includes an apparatus for connecting a threaded spout of a hearing assistance device to an acoustic sound conduit, the apparatus having a first portion having an adaptor passageway adapted to mate to the spout; and a second portion adapted to provide a interference fit with the acoustic sound conduit; wherein the apparatus is adapted to connect the hearing assistance device and the acoustic sound conduit such that the hearing assistance device, the apparatus, and acoustic sound conduit define an acoustically sealed passageway extending from within the hearing assistance device and through the acoustic sound conduit.

The present subject matter includes several variations. In some embodiments, the adaptor passageway is linear. In additional embodiments it is at least partially threaded. In some embodiments it is cylindrical.

In some embodiments, the adaptor is sealed to a spout using threads. In other embodiments, a seal is created by connecting the adaptor and the spout with a seal disposed therebetween. Seals within the present scope include o-ring and washer types.

The present subject matter, in various embodiments, includes a nipple at which a sound conduit is connected. The nipple may continuously stretch the sound conduit. The nipple defines part of the adaptor passageway, in various embodiments.

An additional embodiment of the present subject matter includes an apparatus for connection to a threaded spout of a hearing assistance device, the apparatus having an adaptor having a first portion with an adaptor passageway adapted to mate to the threaded spout, and a second portion interference fitted to an acoustic sound conduit, wherein the apparatus is adapted to connect the hearing assistance device such that the hearing assistance device, the adaptor, and acoustic sound conduit define an acoustically sealed passageway extending from within the hearing assistance device and through the acoustic sound conduit.

Additionally, an embodiment of the present subject matter includes an apparatus for an ear, the apparatus having a hearing assistance device housing shaped to fit at least partially behind the ear, the hearing assistance device housing containing a microphone, sound processing electronics, and a speaker to deliver sound to a spout at an aperture in the hearing assistance device housing; an adaptor having an adaptor passage acoustically sealed to the aperture in the hearing assistance device housing; and a sound conduit defining a lumen which is acoustically sealed, at a proximal portion, to the adaptor passage of the adaptor.

This Summary is an overview of some of the teachings of the present application and not intended to be an exclusive or exhaustive treatment of the present subject matter. Further details about the present subject matter are found in the detailed description and appended claims. Other aspects will be apparent to persons skilled in the art upon reading and understanding the following detailed description and viewing the drawings that form a part thereof, each of which are not to be taken in a limiting sense. The scope of the present invention is defined by the appended claims and their legal equivalents.

### BRIEF DESCRIPTION OF THE DRAWINGS

FIG. 1 shows a perspective view of an assembly including a hearing assistance device housing, a spout, an adaptor, a sound conduit, and an earpiece, according to one embodiment of the present subject matter.

FIG. 2 is a schematic showing an adaptor, a hearing assistance device housing and a sound port, according to one embodiment of the present subject matter.

FIG. 3 shows a perspective view of an adaptor attached to a sound conduit, according to one embodiment of the present subject matter.

FIG. 4 shows a side view of a hearing assistance device housing and a side view partial cross section of an adaptor and a spout, according to one embodiment of the present subject matter.

FIG. 5 shows a side view of an adaptor, according to one embodiment of the present subject matter.

FIG. 6 shows a side view of a spout, according to one embodiment of the present subject matter.

FIG. 7 shows an assembly including a spout and an adaptor, according to one embodiment of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

The present subject matter is directed toward hearing assistance devices. Many hearing assistance devices include a spout. Often, the spout is threaded, and includes a passageway adapted to transmit acoustic sound. Some users seek to attach parts to the spout which are not compatible with the spout. For instance, some incompatible parts lack threads to match the threads of a spout. Such an assembly often demonstrates air gaps between the incompatible part and the spout. Air gaps can cause feedback and can decrease performance. In various embodiments, the present subject matter provides an adaptor which provides for the connection of otherwise incompatible parts to the threaded spout.

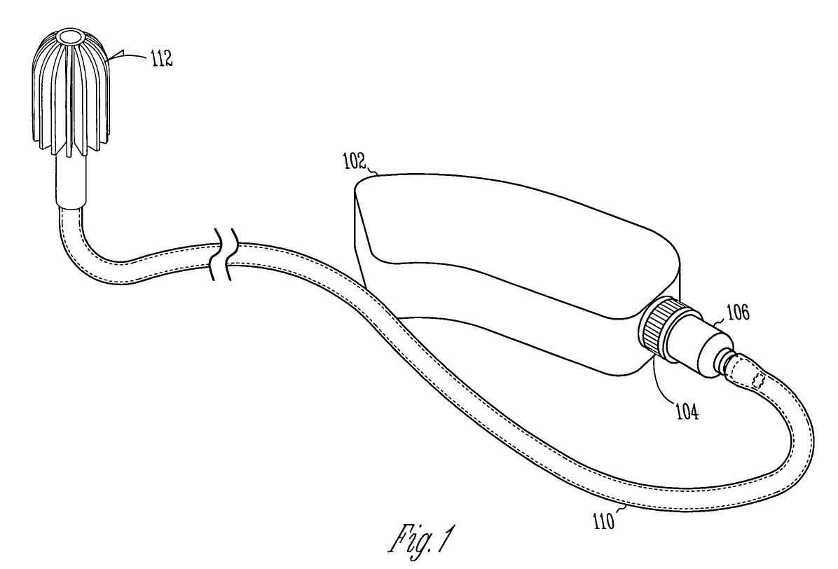

FIG. 1 shows a perspective view of an assembly including a hearing assistance device housing, a spout, an adaptor, a sound conduit, and an earpiece, according to one embodiment of the present subject matter. The present illustration shows one embodiment of a hearing assistance device housing 102. In various embodiments, the hearing assistance device housing 102 is shaped to fit at least partially behind an ear. This configuration is known in the art as a behind-the-ear (“BTE”) configuration. Optional configurations within the scope of the present subject matter extend beyond embodiments using BTE housings.

The pictured configuration shows an adaptor 106 connected to a spout 104. In some embodiments, the spout is a separate piece which is acoustically sealed to the hearing assistance device housing 102. In some hearing assistance device designs, the spout 104 is integrated with the housing. The spout, in various embodiments, includes a passageway. As such, in embodiments in which the spout 104 is integrated with the housing 102, the spout 104 at least partially defines an aperture in the hearing assistance device housing 102. Overall, the present subject matter includes spout embodiments in which the spout provides for an acoustically sealed sound passageway for sound emanating from within the hearing assistance device housing 102.

In various embodiments, the spout is a hollow, cylindrical boss having threads. These threads are suited for attachment of a device, such as a plastic ear hook, in various embodiments. Such a spout configuration, however, does not provide for a sealable connection to some parts. For instance, some sound conduits are not compatible with the threads of the spout. As such, embodiments within the present scope provide an adaptor 106 adapted to form an acoustically sealed connection to the spout 104. Adaptor 106, in various embodiments, is suited for mating with a sound conduit 110 such that an acoustic seal exists between the hearing assistance device housing 102, the spout 104, the adaptor 106, and the sound conduit 110.

Various forms of sound conduit 110 are used in the present subject matter. In some embodiments, a sound tube is used. In some embodiments, the sound conduit 110 is continuous and defines an acoustically sealed lumen. Some embodiments are not continuous and include multiple subcomponents. Some embodiments include a sound conduit 110 which is rubber or which has rubber subcomponents. Additional embodiments within the present subject matter include other materials. In various embodiments, a sound conduit 110 defines a lumen used to transmit sound in an acoustically sealed manner.

In various embodiments, the sound conduit is acoustically sealed to the adaptor 106 at a proximal end, and is acoustically sealed to an earpiece 112 at a distal end. In various embodiments, the earpiece 112 is shaped to at least partially fit an ear canal of the ear. Additional embodiments do not include an earpiece. Some of these embodiments terminate in a distal aperture which is shaped for positioning nearby an ear canal.

In some embodiments, the sound conduit is sized to fit the ear. These embodiments include designs in which the sound conduit 110 provides support for the hearing assistance device housing 102 and the earpiece 112. In some of these embodiments, the sound conduit has rigidity such that it fastens the distal portion of the sound conduit near the ear canal, and further fastens the hearing assistance device housing at least partially behind the ear. In some embodiments, the sound conduit 110 extends over the ear.

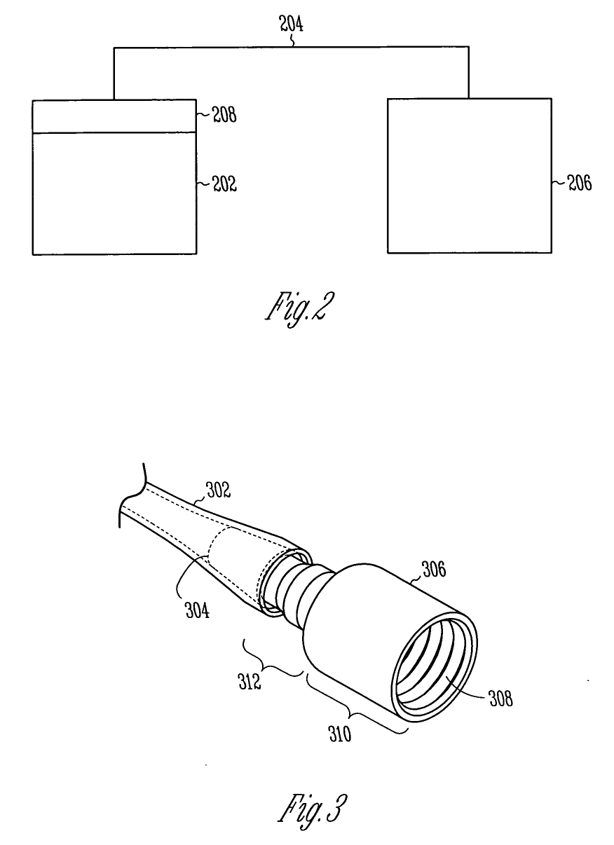

FIG. 2 is a schematic showing an adaptor, a hearing assistance device housing and a sound port, according to one embodiment of the present subject matter. Various embodiments include an adaptor 208 connected to a sound conduit 204. In various embodiments, the sound conduit 204 is connected to a sound port 206. In various embodiments, the sound port 206 is an aperture in the sound conduit 204. In additional embodiments, the sound port 206 is defined within an earpiece. Overall, the interconnected hearing assistance device 202, adaptor 208, sound conduit 204 and sound port 206 define an acoustically sealed passageway extending from within the hearing assistance device 202 to the sound port 206, in various embodiments.

In some embodiments, sound conduit 204 and sound port 206 are assembled from part of a kit. Such kits, in various embodiments, additionally include adaptor 208. In some embodiments, these kits provide a user with the ability to adapt a non-threaded sound conduit to a threaded hearing assistance device spout. These kit embodiments additionally provide the user with several options for earpiece use. Users having such tools are able to adapt a preferred sound conduit, which is incompatible with a threaded spout, to the threaded spout.

In some embodiments, a hearing assistance device having a spout with an ear hook connected to the spout is disassembled such that the spout is exposed. Adaptor 208 is attached to the spout such that a sound tube is used in place of the hook.

One should note that the present subject matter is useful in a variety of applications besides kit embodiments. Such applications include use with new hearing assistance devices, use as new assemblies for attachment to housings, use as retrofit kits, and other uses.

FIG. 3 shows a perspective view of an adaptor attached to a sound conduit, according to one embodiment of the present subject matter. The present subject matter includes multiple adaptor designs. In some embodiments, the adaptor 306 is plastic. In additional embodiments, adaptor 306 is metal. Some embodiments of adaptor 306 include machined steel. Some embodiments of adaptor 306 include brass.

For explanation, the pictured adaptor 306 is represented in two portions: a first portion 310 and a second portion 312. In some of these embodiments, an acoustically sealed adaptor passageway extends continuously through both of these portions. In some embodiments, threads 308 extend along the adaptor passageway at least partially through the first portion 310. In various embodiments, these threads 308 are mateable to threads of a spout. In some assembled embodiments, the threads 308 of the adaptor 306 form an acoustic seal with the threads of the spout.

In some embodiments, the adaptor 306 includes a non-threaded portion of the adaptor passageway which forms an acoustically sealed connection with the spout. As such, in some assembled embodiments, the spout threads are self starting and are engaged with the adaptor passageway defining a mating seal with the spout.

Regarding the second portion 312, various embodiments include a nipple through which the adaptor passageway extends. In some embodiments, the nipple includes a barb 304 which is adapted for mating with a sound conduit 302. Other designs for the second portion 312 which are adapted to attach to a sound conduit additionally fall within the present scope. Lips, ridges, and other attachment designs work within the present scope. Additionally, male tubes sized for mating with a female aperture in the sound conduit also fall within the present scope.

In various embodiments, the sound conduit 302 is stretched over a friction fit portion of the second portion 312. In some embodiments, a sound conduit is stretched over a barb 304 of a nipple of the second portion 312. In some additional embodiments, the sound conduit 302 is only momentarily stretched during installation, and exhibits minimal elastic stretch in use.

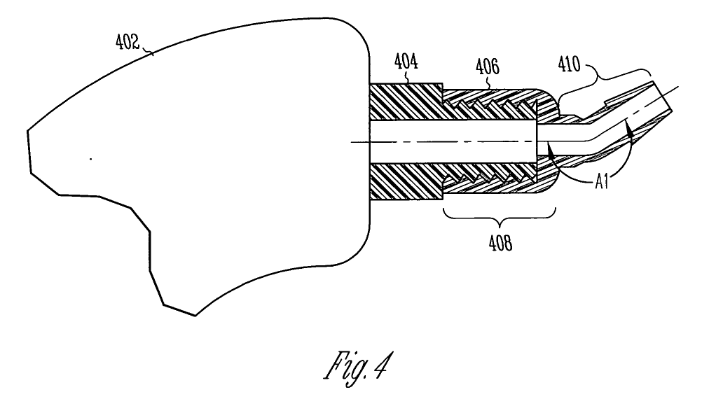

FIG. 4 shows a side view of a hearing assistance device housing and a side view partial cross section of an adaptor and a spout, according to one embodiment of the present subject matter. Various embodiments include a hearing assistance device housing 402, a spout 404, and an adaptor 406. The embodiment illustrated demonstrates spout threads mated to adaptor threads.

The illustrated embodiment shows an adaptor variation in which a first portion 408 of the adaptor 406 and a second portion 410 of the adaptor include a bend. In one embodiment, a generally tubular, acoustically sealed passage is angled at an angle A1. Angle A1 is selectable based on design needs. Some designs are straight, and other designs are angled to suit user comfort.

In various embodiments, the present subject matter includes a seal disposed between the adaptor 406 and the spout 404. For instance, some embodiments include one or more o-rings disposed between the adaptor 406 and the spout 404. O-rings made from rubber fall within the present scope of embodiments. Additional materials are also possible. Further, some embodiments include a washer. Some of these embodiments include a washer having a low durometer rubber. Other sealing methods, including films, adhesives, and other sealing technologies additionally fall within the present scope.

FIG. 5 shows a side view of an adaptor, according to one embodiment of the present subject matter. The embodiment includes an adaptor having a first portion 502 and a second portion 510. In various embodiments, the second portion includes a barb 506. In various embodiments, the first portion 502 is mateable to a hearing assistance device. In some embodiments, the second portion 510 is mateable to a sound conduit. In various embodiments, the adaptor is generally tubular and the second portion 510 has a smaller diameter than the first portion 502. Additionally pictured are threads 504. The material of the adaptor 502 defines an adaptor passageway 508. The following table includes dimensions for the embodiment.

TABLE 1
Dimensions

| Dimension Name | Value |
|---|---|
| D1 | 0.300 inches |
| D2 | 0.229 inches |
| D3 | 0.191 inches |
| D4 | 0.179 inches |
| D5 | 0.159 inches |
| D6 | 0.129 inches |
| D7 | 0.140 inches |
| D8 | 0.070 inches |
| D9 | 0.058 inches |
| D10 | 0.040 inches |
| D11 | 0.049 inches |
| D12 | 0.069 inches |
| D13 | 98.1 degrees |

The dimensions listed in table 1 are approximate. The present subject matter includes dimensions having respective tolerances. For instance, in one embodiment, the linear dimensions D1-D13 each have a tolerance of +/−0.001 inches. The angular dimension, according to some manufacturing embodiments, has a tolerance of +/−0.5 degrees. It should be noted that these dimensions are directed toward one embodiment, and other embodiments within the scope of the present subject matter include other dimensions which vary from the dimensions of Table 1.

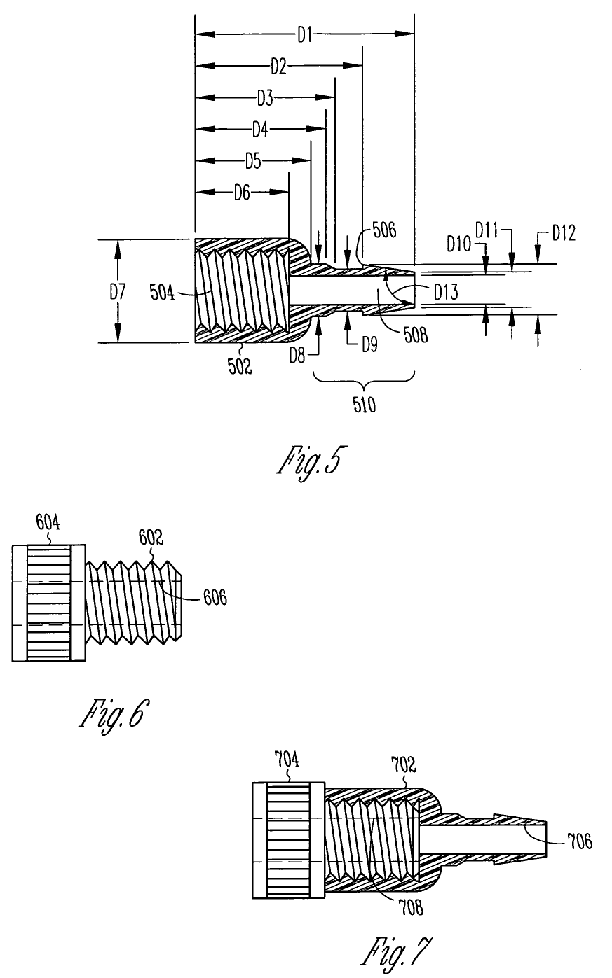

FIG. 6 shows a side view of a spout, according to one embodiment of the present subject matter. Pictured are threads 602 of the spout. Additionally pictured is a spout base 604. Some embodiments include a spout base, and some embodiments include threads which extend to the hearing assistance device. The present subject matter includes embodiments in which the spout base extends away from the hearing assistance device at different lengths. In some embodiments, spout base 604 includes a surface texture. Other embodiments are smooth. The material of the spout defines a spout passageway 606.

FIG. 7 shows an assembly including a spout and an adaptor, according to one embodiment of the present subject matter. Pictured are the adaptor 702 and the spout 704. The threads of the adaptor 702 and the spout 704 are shown interlocked. In such an embodiment, the present subject matter provides for an acoustic seal along a passageway including adaptor passageway 706 and spout passageway 708.

Although specific embodiments have been illustrated and described herein, it will be appreciated by those of ordinary skill in the art that any arrangement which is calculated to achieve the same purpose may be substituted for the specific embodiment shown. This application is intended to cover adaptations or variations of the present subject matter. It is to be understood that the above description is intended to be illustrative, and not restrictive. Combinations of the above embodiments, and other embodiments will be apparent to those of skill in the art upon reviewing the above description. The scope of the present subject matter should be determined with reference to the appended claims, along with the full scope of equivalents to which such claims are entitled.

What is claimed is:

1. An apparatus to connect an acoustic sound conduit to a threaded spout of a hearing assistance device, comprising:
a threaded end to mate with threads of the threaded spout and a second portion adapted to provide an interference fit with the acoustic sound conduit,
wherein the adaptor provides an acoustically sealed passage between the hearing assistance device and the acoustic sound conduit.

2. The apparatus of claim 1, wherein the acoustically sealed passage is approximately linear.

3. The apparatus of claim 1, wherein the second portion is generally tubular and has a smaller diameter than the threaded end.

4. The apparatus of claim 3, wherein the apparatus includes a nipple.

5. An apparatus for connection to a threaded spout of a hearing assistance device, the apparatus comprising:
an adaptor fitted to an acoustic sound conduit, the adaptor including a threaded end to mate with threads of the threaded spout;
wherein the adaptor and the acoustic sound conduit provide an acoustically sealed passage adapted to communicate sound with the hearing assistance device.

6. The apparatus of claim 5, wherein the adaptor includes a nipple.

7. The apparatus of claim 6, wherein the acoustic sound conduit is stretched over the nipple.

8. The apparatus of claim 5, wherein an earpiece is acoustically sealed to the acoustic sound conduit.

9. The apparatus of claim 8, wherein the sound conduit is shaped to fit an ear.

10. The apparatus of claim 9, wherein the adaptor passageway is approximately linear.

11. An apparatus comprising:
a hearing assistance device housing containing a microphone, sound processing electronics, and a speaker to deliver sound to an aperture in the hearing assistance device housing;
an adaptor acoustically sealed to the aperture in the hearing assistance device housing; and
a sound conduit connected to the adaptor,
wherein an acoustically sealed sound passageway extends through the hearing assistance device, the adaptor and the sound conduit.

12. The apparatus of claim 11, wherein the adaptor passage is approximately linear.

13. The apparatus of claim 11, wherein the adaptor has threads mated to the threaded spout.

14. The apparatus of claim 13, wherein the adaptor includes a deformed material mated to the threads of the threaded spout and defining an acoustic seal.

15. The apparatus of claim 11, wherein the adaptor has a first portion mated to the hearing assistance device, and a second portion mated to the sound conduit, and the adaptor is generally tubular and the second portion has a smaller diameter than the first portion.

16. The apparatus of claim 15, wherein the adaptor includes a nipple.

17. The apparatus of claim 16, wherein the second portion includes a nipple, with the sound conduit stretched over the nipple.

18. The apparatus of claim 11, wherein a seal is disposed between the adaptor and the threaded spout.

19. The apparatus of claim 18, wherein the seal is an o-ring.

20. The apparatus of claim 18, wherein the seal is a washer.
